(19) United States
(12) Patent Application Publication
(10) Pub. No.: US 2006/0165183 A1
(43) Pub. Date: Jul. 27, 2006

(54) Image compression apparatus and image compression method

(75) Inventors: Yutaka Numajiri, Hachioji-shi (JP); Ryuji Sakai, Hanno-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/335,017

(22) Filed: Jan. 18, 2006

(30) Foreign Application Priority Data
Jan. 24, 2005 (JP) 2005-015066

(51) Int. Cl. H04B 1/66; H04N 11/04; H04N 11/02; H04N 7/12

(52) U.S. Cl. 375/240.29; 375/240.01

(57) ABSTRACT

An image compression apparatus of this invention has an input unit configured to input image data of a moving picture, a first encoding processor configured to apply compression-encoding processing to the image data input from the input unit using a plurality of compression-encoding modes, a remaining battery level management unit configured to manage the remaining battery level of hardware on which the image compression apparatus is mounted, and a first controller configured to limit some of the plurality of compression-encoding modes which are configured to be processed by the first encoding processor when the remaining battery level managed by the remaining battery level management unit becomes lower than a predetermined setting value.

### CROSS-REFERENCE TO RELATED APPLICATIONS

This application is based upon and claims the benefit of priority from prior Japanese Patent Application No. 2005-015066, filed Jan. 24, 2005, the entire contents of which are incorporated herein by reference.

### BACKGROUND OF THE INVENTION

1. Field of the Invention

The present invention relates to an image compression apparatus and image compression method.

2. Description of the Related Art

As a compression method in a general television receiver, a block matching method for detecting a motion vector from a moving picture is used.

In this block matching method, evaluation values indicating the degrees of correlation of images between a block to be encoded as an object which is to undergo motion vector detection, and candidate blocks having the same size as the block to be encoded within a search range are calculated. Then, a displacement from a block at the same position as the block to be encoded to a candidate block which has a highest degree of correlation indicated by the evaluation value is calculated as a motion vector.

As the evaluation value of the degree of correlation, the sum total of difference absolute values of corresponding pixels between blocks is used. In this case, the evaluation value becomes smaller with increasing degree of correlation between images.

In the block matching method, since evaluation value calculations with respective candidate blocks within the search range are made for one block to be encoded, some methods for reducing the calculation volume of the evaluation value calculations to lower power consumption are available.

As one of such method, Jpn. Pat. Appln. KOKAI Publication No. 11-136682 discloses a method of using a plurality of blocks to be encoded, and controlling the number of blocks to be encoded, which are to be enabled, in accordance with the remaining battery level. If the remaining battery level is sufficient, all blocks to be encoded are used. On the other hand, if the remaining battery level is low, the number of blocks to be encoded, which are to be used, is limited to prolong the battery service life.

Also, as image compression methods, H.264 and VC1 (Microsoft VC1 codec) are known. In these image compression methods, a plurality of block sizes and prediction modes are prepared. A large number of compression encoding modes can be searched for an optimal compression method upon encoding. A high compression ratio can be assured by optimally searching these modes. However, the calculation volume required in encoding increases, and power consumption becomes higher. For this reason, for example, when the remaining battery level becomes low, moving picture encoding is disabled.

### BRIEF SUMMARY OF THE INVENTION

According to an embodiment of the present invention, an image compression apparatus comprises an input unit configured to input image data of a moving picture, a first encoding processor configured to apply compression-encoding processing to the image data input from the input unit using a plurality of compression-encoding modes, a remaining battery level management unit configured to manage a remaining battery level of hardware on which the image compression apparatus is mounted, and a first controller configured to limit some of the plurality of compression-encoding modes which are configured to be processed by the first encoding processor when the remaining battery level managed by the remaining battery level management unit becomes lower than a predetermined setting value.

According to an embodiment of the present invention, a method for compressing an image using an image compression apparatus having an input unit configured to input image data of a moving picture, comprises inputting image data of a moving picture to the input unit, applying compression-encoding processing to the input image data using a plurality of compression-encoding modes, managing a remaining battery level of hardware on which the image compression apparatus is mounted, and limiting some of the plurality of compression-encoding modes when the remaining battery level becomes lower than a predetermined setting value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is a block diagram showing an example of the principal arrangement associated with an image compression apparatus to which an image compression method of the present invention is applied;

FIG. 2 shows an example of a plurality of compression encoding modes in the image compression apparatus to which the image compression method of the present invention is applied;

FIG. 3 shows an example of a plurality of prediction modes in the image compression apparatus to which the image compression method of the present invention is applied;

FIG. 4 shows another example of a plurality of prediction modes in the image compression apparatus to which the image compression method of the present invention is applied; and

FIG. 5 is a flowchart for explaining an example of the operation of the image compression apparatus to which the image compression method of the present invention is applied.

### DETAILED DESCRIPTION OF THE INVENTION

The best embodiments of the present invention will be described hereinafter. The present invention is not limited to these embodiments, and can be variously modified and used.

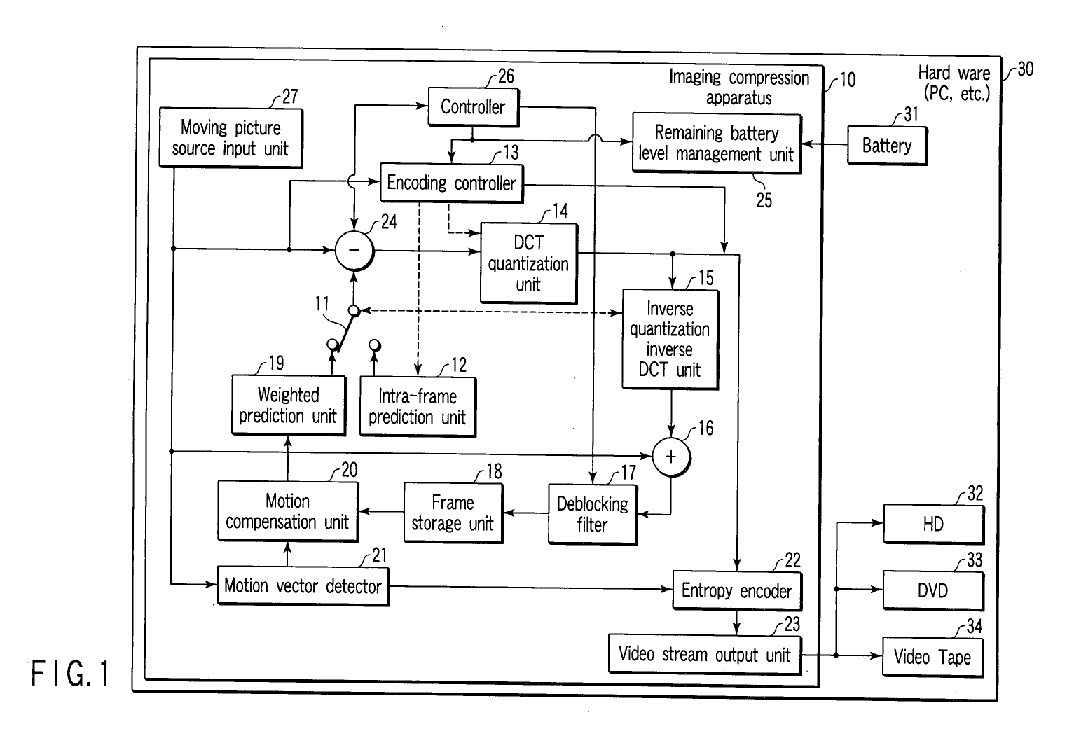

FIG. 1 is a block diagram showing a principal signal processing system of an image compression apparatus 10 to which an image compression method of the present invention is applied. As shown in FIG. 1, this image compression apparatus 10 has a switch 11, intra-frame prediction unit 12, encoding processor 13, discrete cosine transform (DCT) quantization unit 14, inverse quantization inverse discrete cosine transform (inverse DCT) unit 15, adder 16, deblocking filter 17, frame storage unit 18, weighted prediction unit 19, motion compensation unit 20, motion vector detector 21, entropy encoder 22, video stream output unit 23, subtracter 24, and moving picture source input unit 27. The image compression apparatus 10 also has a remaining battery level management unit 25 which manages the remaining level of a battery 31 of hardware 30 such as a personal computer or the like on which the image compression apparatus 10 is mounted. Furthermore, the image compression apparatus 10 has a controller 26 which controls the encoding processor 13 and deblocking filter 17 in accordance with the remaining battery level information of the remaining battery level management unit 25.

The operation of this image compression apparatus 10 will be described below. As shown in FIG. 1, image data of a moving picture input from the moving picture source input unit 27 is input to the encoding processor 13, subtracter 24, adder 16, and motion vector detector 21.

The encoding processor 13 can process according to, e.g., H.264 or VC1 on the basis of the image data input to it. In the following description, a case will be exemplified wherein a mode is selected from a plurality of compression encoding modes (to be described later) to approximate a generated information volume to a target value using H.264, and encoding parameters and the like are determined.

At this time, of the image data input to the encoding processor 13, intra-coded picture (I-picture) data undergoes intra-frame prediction by the intra-frame prediction unit 12 to generate a prediction signal. After that, the switch 11 is connected to the intra-frame prediction unit 12 side to generate a difference from the predicted value by the subtracter 24. This difference is input to the DCT quantization unit 14 to undergo compression encoding, and is further input to the entropy encoder 22 to undergo compression. Then, the compressed difference is output from the video stream output unit 23.

Predictive coded picture (P-picture) and bidirectionally predictive coded picture (B-picture) data are compression-encoded by the DCT quantization unit 14, are further compressed by the entropy encoder 22, and are then output from the video stream output unit 23. After the processing of the DCT quantization unit 14, the image data undergoes inverse processing by the inverse quantization inverse DCT unit 15, and is added to an image of the current frame by the adder 16, thus generating a predicted image of the next frame. After that, block noise is removed from the generated frame by the deblocking filter 17, and that frame is stored in the frame storage unit 18. Furthermore, the motion vector detector 21 detects the direction and magnitude of an object motion, and the motion compensation unit 20 generates an effective predicted frame from the detection result. While the switch 11 is connected to the weighted prediction unit 19 side, the weighted prediction unit 19 generates a prediction signal having a weighting coefficient and offset value. After that, the subtracter 24 generates a difference between the next frame and predicted value, and the generated difference is stored in a memory (not shown) in the controller 26. Upon compression-encoding the next frame, the difference stored in the memory is used.

In this image compression apparatus 10, when it is determined that the remaining battery level managed by the remaining battery level management unit 25 becomes lower than a setting value, the controller 26 controls to limit some of a plurality of encoding modes which can be selected by the encoding processor 13.

At this time, the controller 26 has a memory (not shown) that holds information associated with the encoding processing of the encoding processor 13. When the remaining battery level becomes higher than the setting value, the controller 26 reads the information held by the memory, and cancels the limitation of the encoding modes using this information.

The controller 26 variably controls the bit rate which can be set by the encoding processor 13 in accordance with the remaining battery level managed by the remaining battery level management unit 25. In this way, the controller 26 raises the bit rate to be higher than the setting value when the remaining battery level becomes lower than the setting value. The controller 26 limits deblocking processing of the deblocking filter 17 in accordance with the remaining battery level managed by the remaining battery level management unit 25. When the remaining battery level becomes lower than the setting value, the controller 26 controls to skip the deblocking processing of the deblocking filter 17.

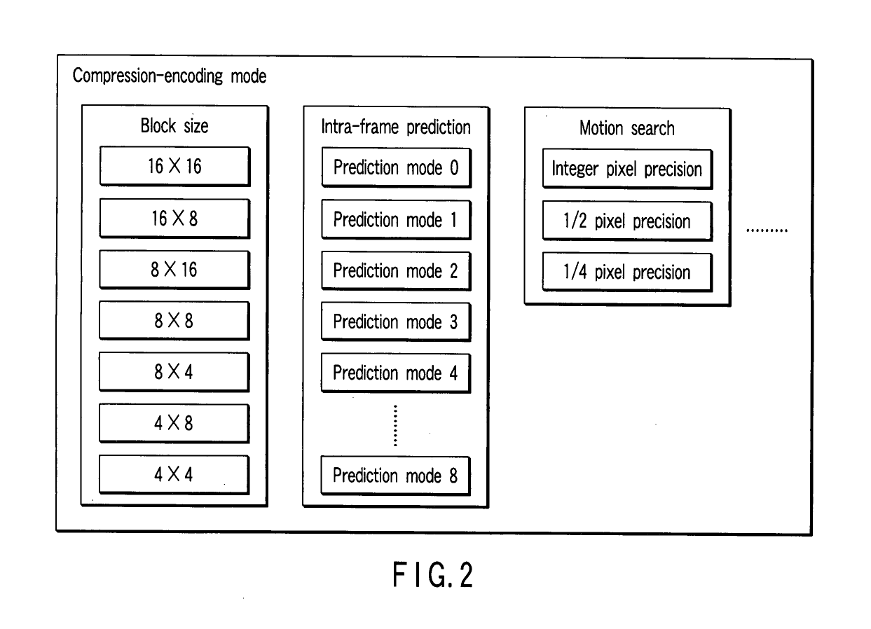

The plurality of compression-encoding modes in the encoding processor 13 will be described below using FIG. 2. As shown in FIG. 2, the encoding processor 13 has compression encoding modes including 16×16, 16×8, 8×16, 8×8, 8×4, 4×8, and 4×4 block sizes, intra-frame prediction modes 0, 1, 2, 3, 4, 5, 6, 7, and 8, motion search modes of integer pixel precision, ½ pixel precision, and ¼ pixel precision, and the like.

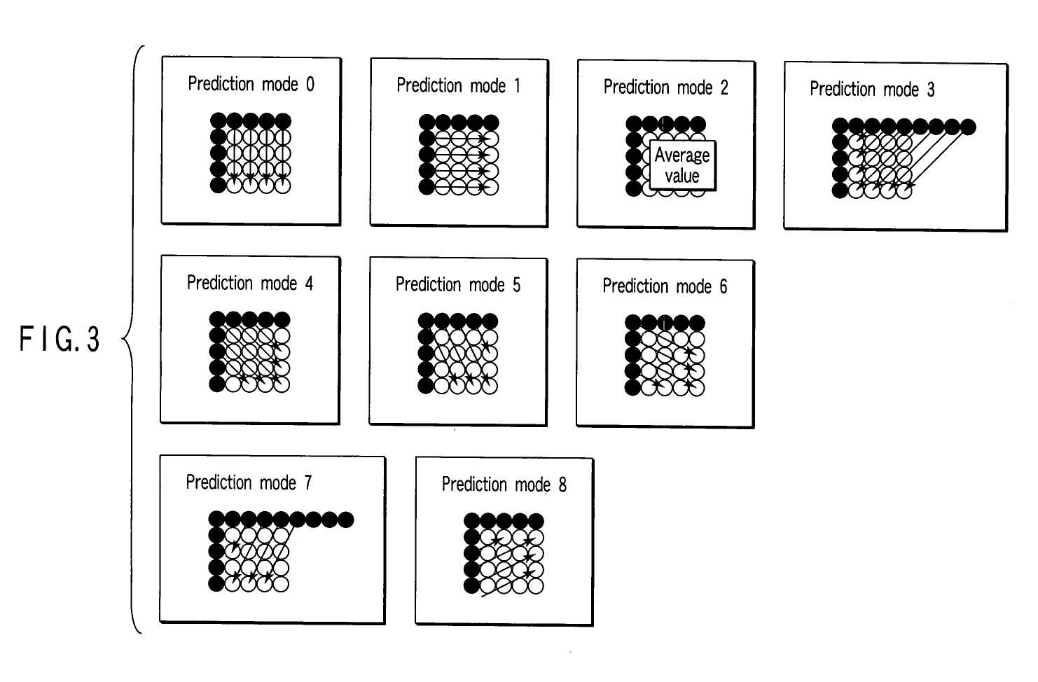

FIG. 3 shows intra-frame prediction modes 0, 1, 2, 3, 4, 5, 6, 7, and 8 of 4×4 blocks of these plurality of modes. As shown in FIG. 3, prediction mode 0 uses the values of the upper row as predicted values of respective columns. Prediction mode 1 uses the values of the left column as predicted values of respective rows. Prediction mode 2 uses the average value of neighboring pixels of the upper row and left column of the block as the predicted value of the entire block. Prediction mode 3 uses the values of the upper row as predicted values of pixels located in the lower left 45° direction. Prediction mode 4 uses the values of the upper row and left column as predicted values of pixels located in the 45° direction. Prediction modes 5 to 8 respectively use neighboring pixel values as predicted values in knight's move jump directions.

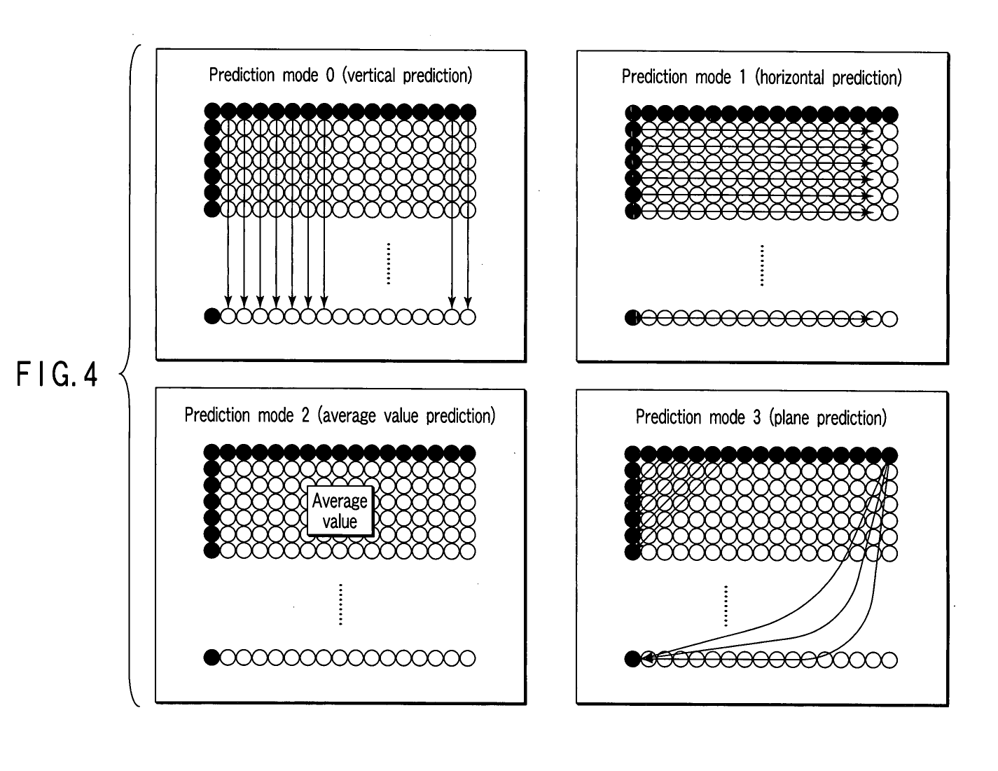

FIG. 4 shows prediction mode 0 (vertical prediction), prediction mode 1 (horizontal prediction), prediction mode 2 (average value prediction), and prediction mode 3 (plane prediction) prepared as the intra-frame prediction modes of 16×16 blocks.

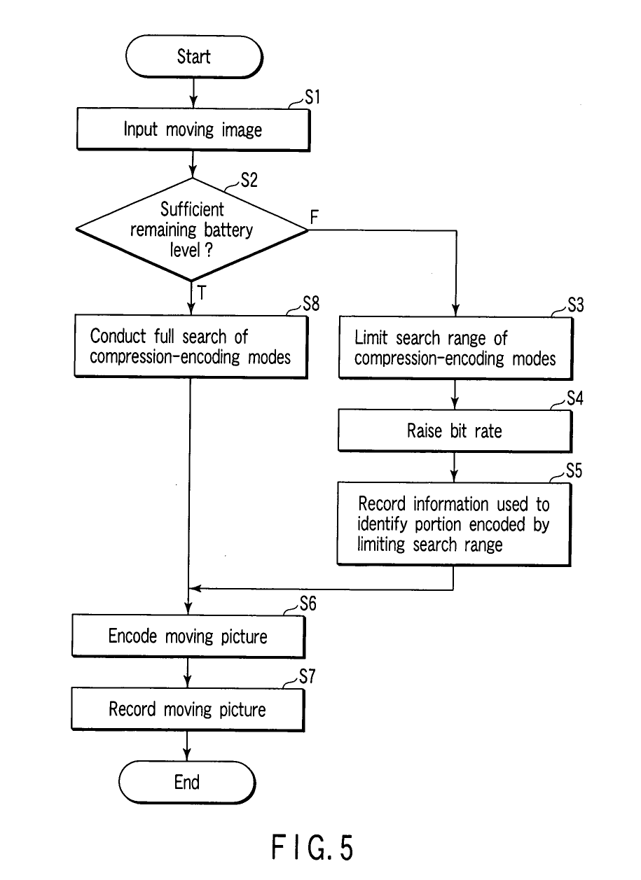

FIG. 5 is a flowchart for explaining an example of the operation of the image compression apparatus 10 to which the image compression method of the present invention is applied. As shown in FIG. 5, image data of a moving picture is input to the moving picture source input unit 27 (S1). The remaining battery level management unit 25 examines whether the remaining level of the battery 31 of the hardware 30 such as a personal computer or the like on which the image compression apparatus 10 is mounted is sufficient (S2). At this time, the remaining battery level management unit, 25 may output data indicating the remaining battery level, and the controller 26 may check if this output value is higher or lower than a pre-set value.

If the remaining battery level is sufficient, i.e., it is higher than a predetermined setting value (S2: T), full search of the compression-encoding modes is conducted (S8). This is to use all the plurality of modes shown in FIG. 2. Next, the moving picture is encoded (S6), and is recorded on a recording medium such as an HD 32 of a personal computer, DVD 33, or videotape 34 via the video stream output unit 23 (S7).

If the remaining battery level is insufficient, i.e., it is lower than the predetermined setting value (S2: F), the search range of the compression-encoding modes is limited (S3). In this case, half or ⅓ of the plurality of modes shown in FIG. 2 is used. The bit rate is raised (e.g., doubled) (S4). Next, information used to identify a portion encoded by limiting the search range is recorded on, e.g., an HD or the like (S5). Then, the moving picture is encoded (S6), and is recorded (S7).

The information used to identify the portion encoded by limiting the search range, which is recorded in step S5, is read and is used to recover the image compression-encoding processing when the remaining battery level is recovered and becomes higher than the predetermined setting value by changing or charging the battery, or by supplying AC power.

As described above, according to the present invention, in the moving picture encoding processing, the encoding modes are limited, the bit rate is varied, or the deblocking filter processing is skipped in accordance with the remaining battery level. When the remaining battery level is sufficient, a high compression ratio is set to execute the encoding processing. When the remaining battery level becomes low, a power saving mode can be set at the expense of the compression ratio.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image compression apparatus comprising:
an input unit configured to input image data of a moving picture;
a first encoding processor configured to apply compression-encoding processing to the image data input from the input unit using a plurality of compression-encoding modes;
a remaining battery level management unit configured to manage a remaining battery level of hardware on which the image compression apparatus is mounted; and
a first controller configured to limit some of the plurality of compression-encoding modes which are configured to be processed by the first encoding processor when the remaining battery level managed by the remaining battery level management unit becomes lower than a predetermined setting value.

2. An apparatus according to claim 1, which further comprises a memory configured to hold information associated with the compression-encoding processing of the first encoding processor,
in which when the remaining battery level becomes higher than the setting value, the first controller reads the information held in the memory and cancels the limitation of the compression-encoding modes using the read information.

3. An apparatus according to claim 1, which further comprises:
a second encoding processor configured to apply compression-encoding processing to the image data input from the input unit at a predetermined bit rate; and
a second controller configured to variably control the bit rate, which can be processed by the second encoding processor, in accordance with the remaining battery level managed by the remaining battery level management unit,
in which when the remaining battery level becomes lower than the predetermined setting value, the second controller raises the bit rate to be higher than a predetermined bit rate.

4. An image compression apparatus comprising:
an input unit configured to input image data of a moving picture;
an encoding processor configured to apply compression-encoding processing to the image data input from the input unit;
a deblocking filter configured to apply deblocking processing to information which has undergone the compression-encoding processing by the encoding processor;
a remaining battery level management unit configured to manage a remaining battery level of hardware on which the image compression apparatus is mounted; and
a controller configured to skip the deblocking processing of the deblocking filter in accordance with the remaining battery level managed by the remaining battery level management unit.

5. An apparatus according to claim 4, wherein when the remaining battery level managed by the remaining battery level management unit becomes lower than a predetermined setting value, the controller controls to skip the deblocking processing of the deblocking filter.

6. An apparatus according to claim 5, wherein the compression-encoding processing is compression-encoding processing according to H.264.

7. An apparatus according to claim 4, wherein the compression-encoding processing is compression-encoding processing according to H.264.

8. An apparatus according to claim 3, wherein the compression-encoding processing is compression-encoding processing according to H.264.

9. An apparatus according to claim 2, wherein the compression-encoding processing is compression-encoding processing according to H.264.

10. An apparatus according to claim 1, wherein the compression-encoding processing is compression-encoding processing according to H.264.

11. A method for compressing an image using an image compression apparatus having an input unit configured to input image data of a moving picture, comprising:
inputting image data of a moving picture to the input unit;
applying compression-encoding processing to the input image data using a plurality of compression-encoding modes;
managing a remaining battery level of hardware on which the image compression apparatus is mounted; and
limiting some of the plurality of compression-encoding modes when the remaining battery level becomes lower than a predetermined setting value.

12. A method according to claim 11, which further comprises:
holding information associated with the compression-encoding processing; and
reading the information held in the memory and canceling the limitation of the compression-encoding modes using the read information when the remaining battery level becomes higher than the setting value.

13. A method according to claim 11, which further comprises:
applying compression-encoding processing to the input image data at a predetermined bit rate; and
variably controlling the bit rate, which can be used in the compression-encoding processing, in accordance with the remaining battery level.

14. A method according to claim 13, which further comprises:
raising the bit rate to be higher than a predetermined bit rate when the remaining battery level becomes lower than the setting value.

15. A method for compressing an image using an image compression apparatus having an input unit configured to input image data of a moving picture, comprising:
inputting image data of a moving picture to the input unit;
applying compression-encoding processing to the input image data;
applying deblocking processing to information which has undergone the compression-encoding processing;
managing a remaining battery level of hardware on which the image compression apparatus is mounted; and
limiting the deblocking processing in accordance with the managed remaining battery level.
